(19) United States
(12) Patent Application Publication
(10) Pub. No.: US 2015/0306812 A1
(43) Pub. Date: Oct. 29, 2015

(54) NANOIMPRINTING MASTER TEMPLATE

(71) Applicant: HGST Netherlands B.V., Amsterdam (NL)

(72) Inventors: He Gao, San Jose, CA (US); Jeffrey S. Lille, Sunnyvale, CA (US)

(21) Appl. No.: 14/790,935

(22) Filed: Jul. 2, 2015

Related U.S. Application Data
(63) Continuation of application No. 13/627,492, filed on Sep. 26, 2012.

(51) Int. Cl. B29C 59/02; B29C 33/38; B29C 43/36

(52) U.S. Cl. CPC B29C 59/022; B29C 43/36; B29C 33/38; B29K 2909/02; B29K 2909/08

(57) ABSTRACT

A nanoimprinting master template is an ultraviolet-transparent substrate, like fused quartz, with a metallic layer having silicon dioxide pillars extending from the metallic layer and an optional silicon dioxide film on the pillars and on regions of the metallic layer between the pillars. The pillars have a generally rectangular shape and are arranged as a pattern of radial spokes and concentric rings.

### RELATED APPLICATION

This application is a continuation of application Ser. No. 13/627,492 filed Sep. 26, 2012.

### BACKGROUND OF THE INVENTION

1. Field of the Invention

This invention relates to a master template to be used for nanoimprinting patterned-media magnetic recording disks.

2. Description of the Related Art

Magnetic recording hard disk drives with patterned magnetic recording media have been proposed to increase data density. In patterned media, the magnetic recording layer on the disk is patterned into small isolated data islands arranged in concentric data tracks. To produce the required magnetic isolation of the patterned data islands, the magnetic moment of spaces between the islands must be destroyed or substantially reduced to render these spaces essentially nonmagnetic. In one type of patterned media, the magnetic material is deposited first on a flat disk substrate. The magnetic data islands are then formed by milling, etching or ion-bombarding of the area surrounding the data islands. In another type of patterned media, the data islands are elevated regions or pillars that extend above “trenches” and magnetic material covers both the pillars and the trenches, with the magnetic material in the trenches being rendered nonmagnetic, typically by “poisoning” with a material like silicon (Si). Patterned-media disks may be longitudinal magnetic recording disks, wherein the magnetization directions are parallel to or in the plane of the recording layer, but are more typically perpendicular magnetic recording disks, wherein the magnetization directions are perpendicular to or out-of-the-plane of the recording layer.

One proposed method for fabricating patterned-media disks is by nanoimprinting with a master disk or template, sometimes also called a “stamper” or “mold”, that has a topographic surface pattern. In this method the magnetic recording disk with a polymer film on its surface is pressed against the template. In one type of patterned media, the magnetic layers and other layers needed for the magnetic recording disk are first deposited on the flat disk substrate. The polymer film is formed on top of these layers. The polymer film receives the reverse image of the template pattern and then becomes a mask for subsequent milling, etching or ion-bombarding the underlying layers to leave discrete islands of magnetic recording material. In another type of patterned media the disk substrate with a polymer film on its surface is pressed against the template. The polymer film receives the reverse image of the template pattern and then becomes a mask for subsequent etching of the disk substrate to form pillars on the disk substrate. Then the magnetic layer and other layers needed for the magnetic recording disk are deposited onto the etched disk substrate and the tops of the pillars to form the patterned-media disk. The template may be a master disk for directly imprinting the disks. However, the more likely approach is to fabricate a master template with a pattern of pillars corresponding to the pattern of pillars desired for the disks and to use this master template to fabricate replica templates. The replica templates will thus have a pattern of recesses or holes corresponding to the pattern of pillars on the master template. The replica templates are then used to directly imprint the disks. In patterned media, it is important that the data islands have the same height above the substrate. This requires the use of a very precise imprint template.

What is needed is a master template and a method for making it that can result in patterned-media magnetic recording disks with data islands having the same height.

### SUMMARY OF THE INVENTION

The invention relates to a method for making a nanoimprinting master template that uses a metallic etch stop layer for two etching steps. An etch stop layer formed of a metallic material resistant to etching in a fluorine-containing plasma is deposited on an ultraviolet-transparent substrate, like fused quart. A layer of silicon dioxide is deposited on the etch stop layer and a first patterned resist layer of resist lands and resist grooves is formed on the silicon dioxide layer. The first resist pattern is either generally concentric rings about the substrate center or generally radial spokes extending from the substrate center. A first mask layer formed of material resistant to etching in a fluorine-containing plasma is then deposited on the resist lands of the first pattern. The resist grooves of the first pattern are etched to expose grooves of silicon dioxide, and the exposed silicon dioxide grooves are etched in a fluorine-containing plasma down to the etch stop layer to expose grooves of the etch stop layer. The resist lands of the first pattern and first mask layer are removed, leaving lands of silicon dioxide on the etch stop layer having the selected pattern of either concentric rings or radial spokes.

Then a second layer of resist is formed over the lands of silicon dioxide and the etch stop layer and patterned into a second pattern of resist lands and resist grooves. The second pattern is the other of the previously selected concentric rings or radial spokes. A second mask layer formed of material resistant to etching in a fluorine-containing plasma is then deposited on the resist lands of the second pattern. The resist grooves of the second pattern are etched to expose regions of silicon dioxide, and the exposed silicon dioxide regions are etched in a fluorine-containing plasma down to the etch stop layer to expose regions of the etch stop layer. The resist lands of the second pattern and second mask layer are removed, leaving pillars of silicon dioxide on the etch stop layer. An optional thin film of silicon dioxide may be deposited by atomic layer deposition over the silicon dioxide pillars and regions of the etch stop layer.

The use of the etch stop layer for both silicon dioxide etching steps, i.e., the first to form the concentric rings or radial spokes and the second to form the pillars, results in the regions surrounding the pillars having the same depth from the tops of the pillars. This assures that all pillars have substantially the same height, which is critical for making the patterned disks.

The invention also relates to a master template that has an ultraviolet-transparent substrate with the metallic etch stop layer on the substrate surface. The metallic layer has a thickness greater than or equal to 1 nm and less than or equal to 5 nm. A plurality of silicon dioxide pillars extend from the metallic layer and are arranged into generally radial spokes and generally concentric rings. The template may have an optional thin film of silicon dioxide over the regions of the metallic layer between the pillars, in which case the metallic layer is embedded within the template.

For a fuller understanding of the nature and advantages of the present invention, reference should be made to the following detailed description taken together with the accompanying figures.

### BRIEF DESCRIPTION OF THE DRAWING

FIG. 1 is a top view of a disk drive with a patterned-media type of magnetic recording disk as described in the prior art.

FIG. 2 is a top view of an enlarged portion of a patterned-media type of magnetic recording disk showing the detailed arrangement of the data islands in one of the bands on the surface of the disk substrate.

FIGS. 3A-3C are sectional views illustrating the general concept of nanoimprinting according to the prior art.

FIGS. 4A-4J illustrate the template according to the invention and the method for making it; wherein FIGS. 4A-4F are sectional views of the template, FIG. 4G is a perspective view of a second mold above the template after it has been patterned with a first mold, FIGS. 4H-4I are top views of scanning electron microscopy (SEM) images of the template, and FIG. 4J is a sectional view of the completed imprint template after deposition of an optional silicon dioxide film.

FIG. 5A is a schematic of a top view of a portion of the prior art imprint template illustrating how regions surrounding the pillars may have different depths.

FIG. 5B is a schematic of a top view of a portion of the imprint template of this invention illustrating how regions surrounding the pillars have the same depth.

### DETAILED DESCRIPTION OF THE INVENTION

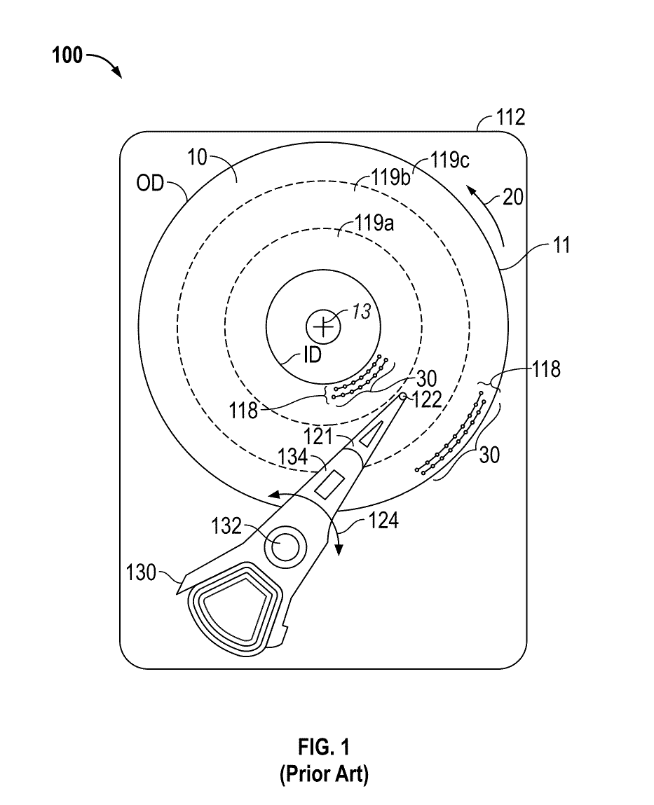

FIG. 1 is a top view of a disk drive 100 with a patterned magnetic recording disk 10 as described in the prior art. The drive 100 has a housing or base 112 that supports an actuator 130 and a drive motor for rotating the magnetic recording disk 10 about its center 13. The actuator 130 may be a voice coil motor (VCM) rotary actuator that has a rigid arm 134 and rotates about pivot 132 as shown by arrow 124. A head-suspension assembly includes a suspension 121 that has one end attached to the end of actuator arm 134 and a head carrier 122, such as an air-bearing slider, attached to the other end of suspension 121. The suspension 121 permits the head carrier 122 to be maintained very close to the surface of disk 10. A magnetoresistive read head (not shown) and an inductive write head (not shown) are typically formed as an integrated read/write head patterned on the trailing surface of the head carrier 122, as is well known in the art.

The patterned magnetic recording disk 10 includes a disk substrate 11 and discrete data islands 30 of magnetizable material on the substrate 11. The data islands 30 function as discrete magnetic bits for the storage of data and are arranged in radially-spaced circular tracks 118, with the tracks 118 being grouped into annular bands 119a, 119b, 119c. The grouping of the data tracks into annular zones or bands permits banded recording, wherein the angular spacing of the data islands, and thus the data rate, is different in each band. In FIG. 1, only a few islands 30 and representative tracks 118 are shown in the inner band 119a and the outer band 119c. As the disk 10 rotates about its center 13 in the direction of arrow 20, the movement of actuator 130 allows the read/write head on the trailing end of head carrier 122 to access different data tracks 118 on disk 10. Rotation of the actuator 130 about pivot 132 to cause the read/write head on the trailing end of head carrier 122 to move from near the disk inside diameter (ID) to near the disk outside diameter (OD) will result in the read/write head making an arcuate path across the disk 10.

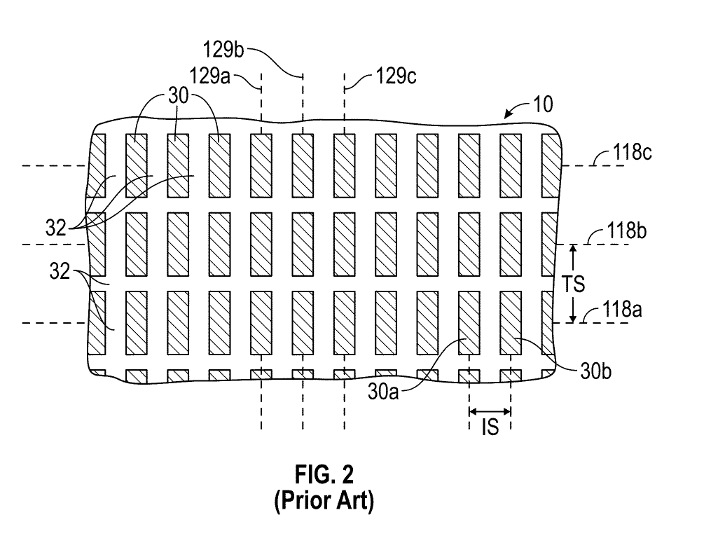

FIG. 2 is a top view of an enlarged portion of disk 10 showing the detailed arrangement of the data islands 30 separated by nonmagnetic regions 32 in one of the bands on the surface of disk substrate 11 according to the prior art. The islands 30 are shown as being generally rectangularly shaped. The islands 30 contain magnetizable recording material and are arranged in tracks spaced-apart in the radial or cross-track direction, as shown by tracks 118a-118c. The tracks are typically spaced apart by a nearly fixed track pitch or spacing TS. Within each track 118a-118c, the islands 30 are roughly equally spaced apart by a nearly fixed along-the-track island pitch or spacing IS, as shown by typical islands 30a, 30b, where IS is the spacing between the centers of two adjacent islands in a track.

The bit-aspect-ratio (BAR) of the pattern of discrete data islands arranged in concentric tracks is the ratio of track spacing or pitch in the radial or cross-track direction to the island spacing or pitch in the circumferential or along-the-track direction. This is the same as the ratio of linear island density in bits per inch (BPI) in the along-the-track direction to the track density in tracks per inch (TPI) in the cross-track direction. In FIG. 2, TS is approximately twice IS, so the BAR is approximately 2.

The islands 30 are also arranged into generally radial lines, as shown by radial lines 129a, 129b and 129c that extend from disk center 13 (FIG. 1). Because FIG. 2 shows only a very small portion of the disk substrate 11 with only a few of the data islands, the pattern of islands 30 appears to be two sets of perpendicular lines. However, tracks 118a-118c are concentric rings centered about the center 13 of disk 10 and the lines 129a, 129b, 129c are not parallel lines, but radial lines extending from the center 13 of disk 10. Thus the angular spacing between adjacent islands as measured from the center 13 of the disk for adjacent islands in lines 129a and 129b in a radially inner track (like track 118c) is the same as the angular spacing for adjacent islands in lines 129a and 129b in a radially outer track (like track 118a).

The generally radial lines (like lines 129a, 129b, 129c) may be perfectly straight radial lines but are preferably arcs or arcuate-shaped radial lines that replicate the arcuate path of the read/write head on the rotary actuator. Such arcuate-shaped radial lines provide a constant phase position of the data islands as the head sweeps across the data tracks. There is a very small radial offset between the read head and the write head, so that the synchronization field used for writing on a track is actually read from a different track. If the islands between the two tracks are in phase, which is the case if the radial lines are arcuate-shaped, then writing is greatly simplified.

Patterned-media disks like that shown in FIG. 2 may be longitudinal magnetic recording disks, wherein the magnetization directions in the magnetizable recording material are parallel to or in the plane of the recording layer in the islands, but are more likely to be perpendicular magnetic recording disks, wherein the magnetization directions are perpendicular to or out-of-the-plane of the recording layer in the islands. To produce the required magnetic isolation of the patterned data islands 30, the magnetic moment of the regions between 32 the islands must be destroyed or substantially reduced to render these spaces essentially nonmagnetic. The term “nonmagnetic” means that the spaces between the islands are formed of a non-ferromagnetic material, such as a dielectric, or a material that has no substantial remanent moment in the absence of an applied magnetic field, or a magnetic material in a trench recessed far enough below the islands to not adversely affect reading or writing. The nonmagnetic spaces may also be the absence of magnetic material, such as trenches or recesses in the magnetic recording layer or disk substrate.

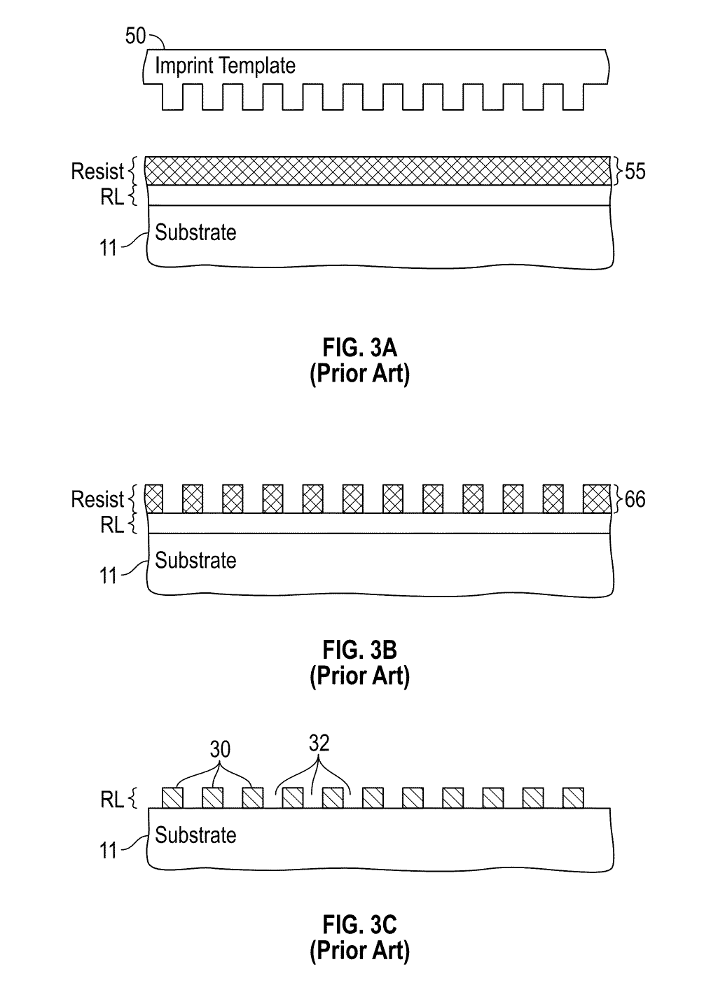

One proposed technique for fabricating patterned magnetic recording disks is by nanoimprinting using a master template. FIGS. 3A-3C are sectional views illustrating the general concept of nanoimprinting. FIG. 3A is a sectional view showing the disk according to the prior art before lithographic patterning and etching to form the data islands. The disk has a substrate 11 supporting a recording layer (RL) having perpendicular (i.e., generally perpendicular to substrate surface) magnetic anisotropy. A layer of imprint resist 55 is formed on the RL. The structure of FIG. 3A is then lithographically patterned by nanoimprinting with a UV-transparent template 50 that has the desired pattern of data islands and nonmagnetic regions. In the prior art the template 50 is typically a fused quartz substrate that has been etched away in different etching steps to form the desired pattern. The template 50 with its predefined pattern is brought into contact with the liquid imprint resist layer, which is a UV-curable polymer, and the template 50 and disk are pressed together. UV light is then transmitted through the transparent template 50 to cure the liquid imprint resist. After the resist has hardened the template is removed, leaving the inverse pattern of the template on the hardened resist layer. The template is separated from the disk and the patterned imprint resist 66 is left. The resulting structure is shown in FIG. 3B. The patterned imprint resist 66 is then used as an etch mask. Reactive-ion-etching (RIE) can be used to transfer the pattern from the imprint resist to the underlying RL. The imprint resist is then removed, leaving the resulting structure of data islands 30 of RL material separated by nonmagnetic regions 32, as shown in FIG. 3C. FIGS. 3A-3C are highly schematic representations merely to illustrate the general nanoimprinting process. The disk would typically include additional layers below the RL. Also the structure of FIG. 3C would typically then be planarized with fill material in the nonmagnetic regions 32, followed by deposition of a protective overcoat and liquid lubricant.

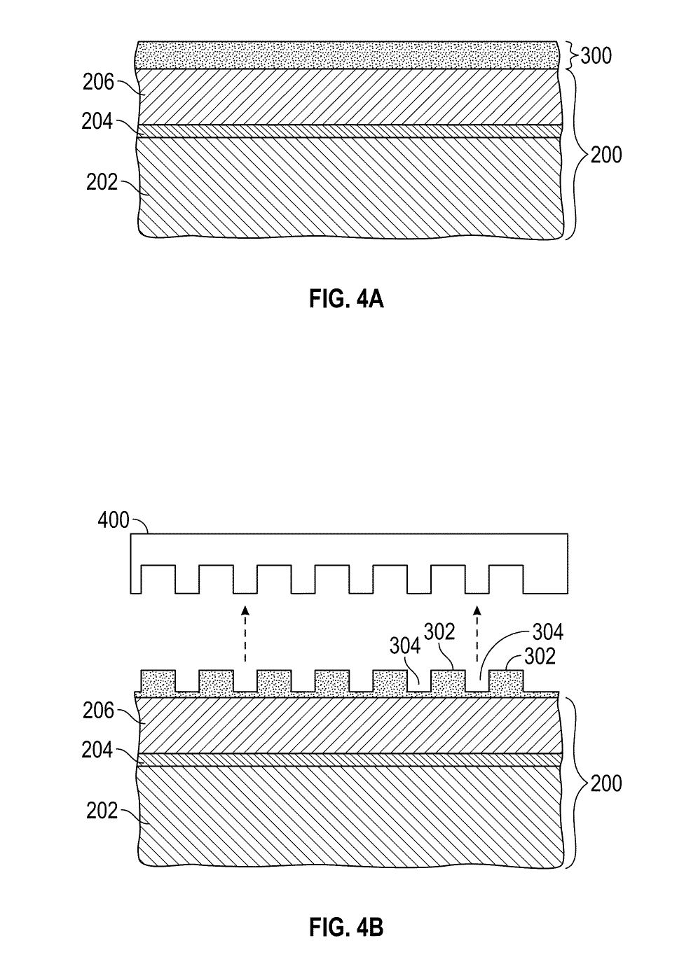

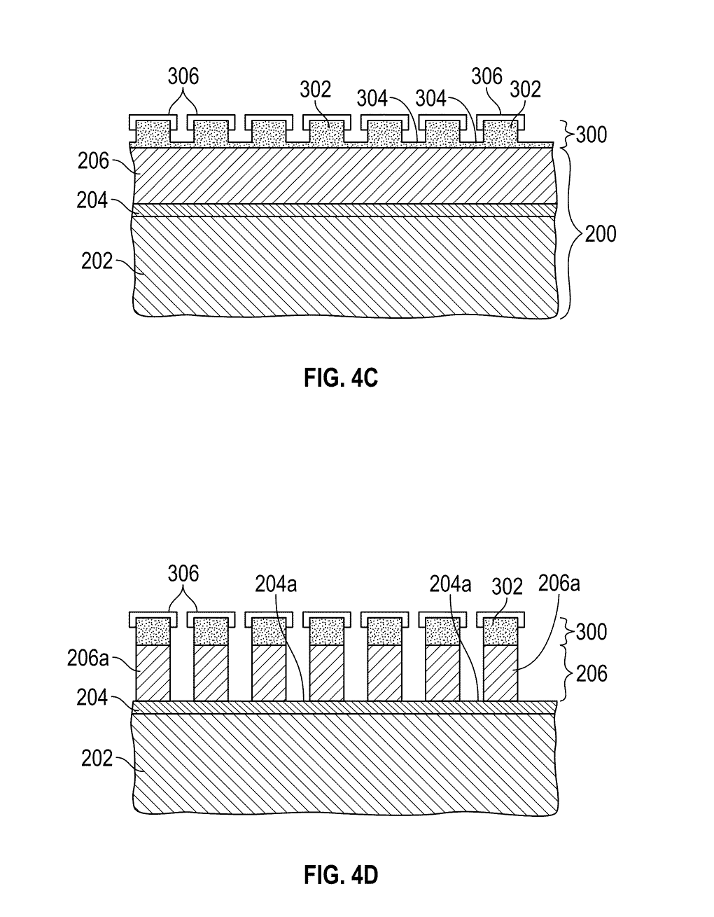

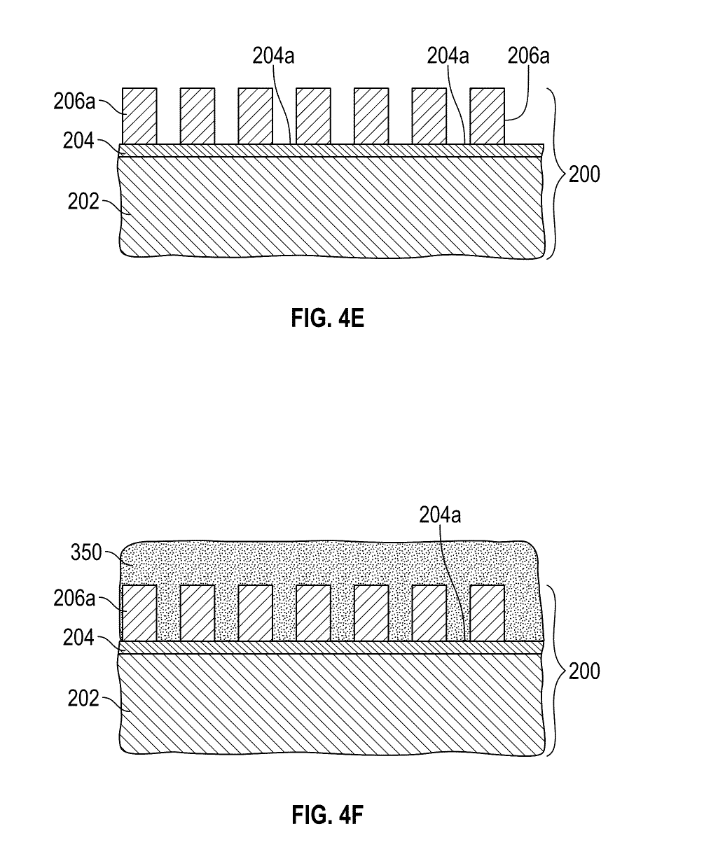

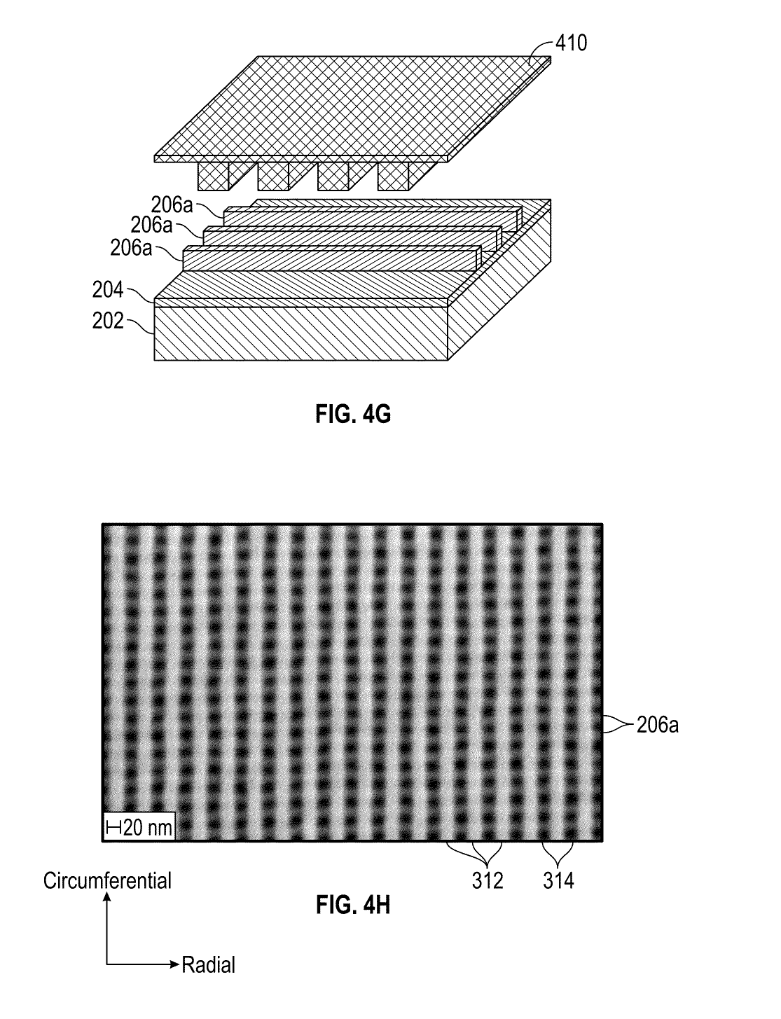

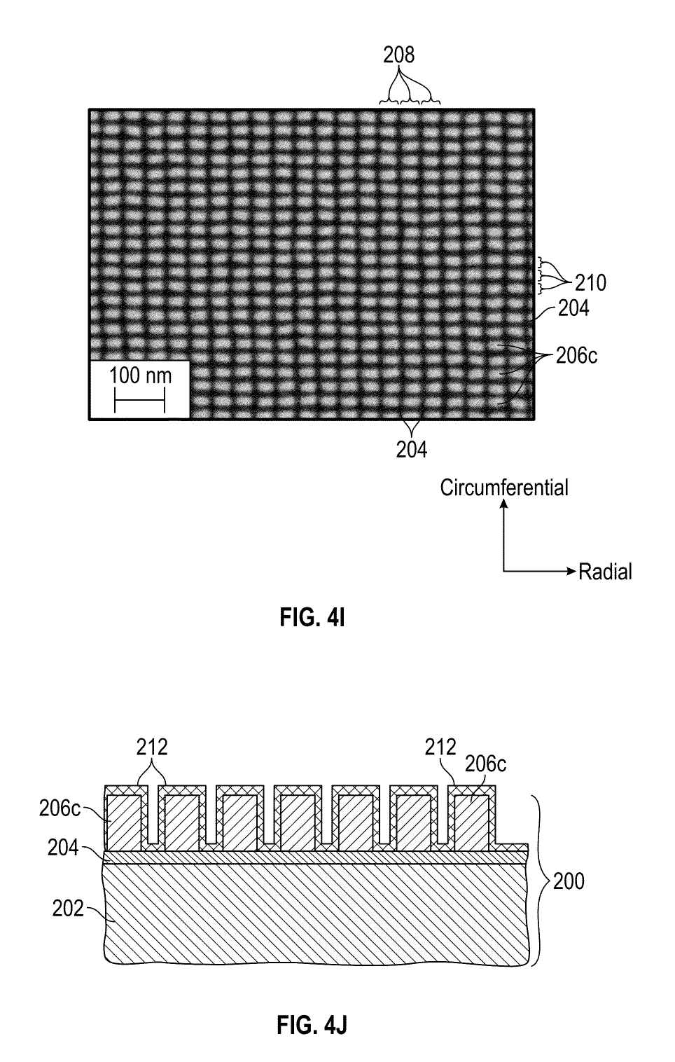

This invention is an improved imprint template for nanoimprinting magnetic recording disks, and a method for making it. The template according to the invention and the method for making it will be described with FIGS. 4A-4J.

FIG. 4A is a sectional view of the imprint template 200 with a layer of imprint resist 300. The imprint resist 300 may be deposited by spin coating or ink jet technology. The imprint template 200 is a fused quartz substrate 202 having an etch stop layer 204 on it and a silicon dioxide (SiO₂) layer 206 on the etch stop layer 204. The fused quartz substrate 202 is transparent to UV radiation because after patterning of the silicon dioxide layer 206 the completed imprint template 200 will ultimately be used to imprint UV-curable resist material that is deposited on the magnetic recording disks. The etch stop layer 204 is formed of a material resistant to reactive ion etching (RIE) in a fluorine-containing plasma, which is the RIE process that will etch the silicon dioxide. Suitable materials for etch stop layer 204 include Cr, Al, Rh, Ru, Ni, Pt, and alloys thereof, as well as oxides of Cr, Al, Cu, Ni, Fe and oxides of their alloys. The etch stop layer 204 remains embedded in the completed imprint template and is thus required to be thin enough, i.e., less than about 5 nm, so as to be transparent to UV radiation. The preferred thickness for etch stop layer 204 is between 1 nm and 5 nm. An optional adhesion layer (not shown) of Ta, Si, Ti, or Cr (if etch stop layer 204 is other than Cr), may be deposited on the substrate 202 to facilitate adhesion of the etch stop layer 204. The silicon dioxide layer 206 has a thickness preferably between 10 and 20 nm. An optional adhesion layer (not shown) of Ta, Si, Ti, Cr (if etch stop layer 204 is other than Cr) with a thickness about of 1 nm may be deposited on the etch stop layer 204 to facilitate adhesion of the subsequently deposited silicon dioxide layer 206.

FIG. 4B is a sectional view of the imprint template 200 after the resist 300 has been patterned with imprinting from a first mold 400 and after the mold 400 has been removed from the resist layer 300 (as depicted by the dashed arrows). The mold 400 has a pattern that forms a pattern of lands 302 and grooves 304 in the resist layer 300. The pattern of lands 302 and grooves 304 is a either a pattern of generally concentric rings about the center of substrate 202 or a pattern of generally radial spokes extending from the center of substrate 202.

FIG. 4C is a sectional view of the imprint template 200 after deposition of a hard mask layer 306 on the tops of resist lands 302. The hard mask material is resistant to RIE in a fluorine-containing plasma, which is the RIE process that will etch the silicon dioxide. The hard mask layer 306 is a metallic layer, i.e., a metal, metal alloy or metal oxide. Thus hard mask layer 306 may be formed of Cr, Cu, Ni, Fe, Al, Pt, or alloys thereof, or metal oxides like chromium oxide and alumina (Al₂O₃). The material of hard mask layer 306 is deposited at a very shallow angle relative to the plane of the substrate through a mask while the substrate 202 is rotated. This assures that the material of hard mask layer 306 is deposited only on the tops of lands 302 and not into the resist grooves 304.

FIG. 4D is a sectional view of the imprint template 200 after removal of resist grooves 304 and after etching of the silicon dioxide layer 206, using the pattern of resist lands 302 with hard mask layer 306 as an etch mask. The silicon dioxide layer 206 is etched down to the etch stop layer 204, leaving a pattern of silicon dioxide lands 206a and grooves 204a of etch stop material. The etching of the silicon dioxide is by RIE in a fluorine-containing plasma, such as CHF₃, or CF₄. The resist lands 302 are then removed by chemically assisted ion beam etching at a shallow angle (e.g., between about 50 and 80 degrees) from normal to the plane of the substrate, or by wet cleaning chemistry such as a solution of ammonium hydroxide, hydrogen peroxide and water, a solution of sulfuric acid and hydrogen peroxide, ozone containing water or a non-polar solvent. This results in a lifting off of the hard mask layer 306, leaving the imprint template 200 having a pattern of either concentric rings or radial spokes of silicon dioxide lands 206a on the etch stop layer 204, depending on which mold was used, as shown in FIG. 4E.

Then a second layer of resist 350 is deposited over the silicon dioxide lands 206a and on the etch stop layer grooves 204a, as shown in FIG. 4F. The process described for FIGS. 4B-4E is then repeated but with a second mold 410 having the pattern that was not selected for first mold 400. For example, if first mold 400 had a pattern of concentric rings, then second mold 410 has a pattern of radial spokes. This is shown in FIG. 4G, which is a perspective view shown with second mold 410 above the structure of FIG. 4E before deposition of second resist layer 350.

FIG. 4H is a top view scanning electron microscopy (SEM) image of a portion of the imprint template after imprinting of second resist layer 350 by second mold 410. The second resist layer 350 has been patterned into rows of lands 312 and grooves 314 above the generally orthogonal rows of silicon dioxide lands 206a. The trenches between silicon dioxide lands 206a are also filled by resist 350 during this imprinting step.

After patterning of the second resist layer 350, deposition of the second hard mask layer, etching of the second resist layer, etching of the silicon dioxide and removal of the second resist layer and second hard mask layer (all as explained above for the first mold with FIGS. 4B-4E) the imprint template 200 is completed. The imprint template 200 now has a pattern of silicon dioxide pillars extending from etch stop layer 204. FIG. 4I is a top view of an SEM image of silicon dioxide pillars 206c (lighter areas) on etch stop layer 204 (darker areas). The pillars 206c are arranged in generally concentric rings 208 and generally radial spokes 210. As shown by the generally rectangular shape of the pillars 206c and the radial spacing of the rings 208, the magnetic recording disks patterned with the imprint template 200 will have data islands with a BAR of approximately 1.5.

FIG. 4J is a sectional view of the completed imprint template 200 after deposition of an optional silicon dioxide film 212 over the silicon dioxide pillars 206 and over the etch stop grooves 204a. The silicon dioxide film 212 may be deposited to a thickness between about 0.5 and 5 nm by atomic layer deposition (ALD). This process is well known but generally described as a thin film deposition technique that is based on the sequential use of a gas phase chemical process, in which by repeatedly exposing gas phase chemicals known as the precursors to the growth surface and activating them with heat or plasma, a precisely controlled thin film is deposited in a conformal manner. The silicon dioxide film 212 over the otherwise exposed etch stop grooves 204a assures that all surfaces of the completed imprint template 200 are covered by silicon dioxide. The silicon dioxide film 212 further protects the etch stop groves 204a and silicon dioxide lands 206c against template cleaning agents such as a solution of ammonium hydroxide, hydrogen peroxide and water, and a solution of sulfuric acid and hydrogen peroxide. This also provides an advantage because silicon dioxide is known to work well with releasing agents, allowing good release properties from the resist after imprinting of the resist on the magnetic recording disks. The master template may undergo many cleaning and reconditioning steps during use to preserve its critical dimensions, for example between 10 to 100 times. Additionally, the silicon dioxide film 212 can be replenished by ALD when the film 212 has been damaged or thinned down by the cleaning agents after template cleaning and reconditioning. This reinforces the protection of etch stop groves 204a and silicon dioxide lands 206c, and maintains the release property of the template.

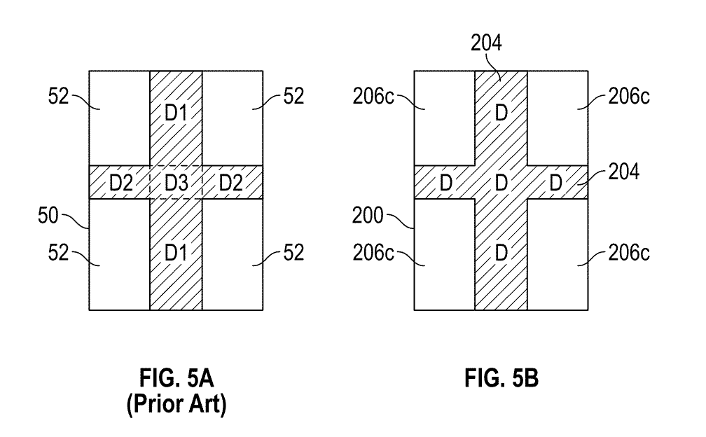

As shown by FIGS. 4I and 4J the etch stop layer 204 remains on the completed imprint template and is embedded in the template in the optional embodiment of FIG. 4J. The etch stop layer, which is used for both silicon dioxide etching steps, i.e., the first to form the concentric rings or radial spokes and the second to form the pillars, assures that all pillars have substantially the same height, which is critical for making the patterned disks. FIG. 5A is a schematic of a top view of a portion of the prior art imprint template 50 illustrating how regions surrounding the pillars 52 may have different depths D1, D2, D3 as a result of direct etching into the fused quartz substrate. FIG. 5B is a schematic of a top view of a portion of the imprint template 200 of this invention illustrating how regions surrounding the pillars 206c have the same depth D above from the tops of the pillars as result of the same etch stop layer 204 used for both etching steps.

While the present invention has been particularly shown and described with reference to the preferred embodiments, it will be understood by those skilled in the art that various changes in form and detail may be made without departing from the spirit and scope of the invention. Accordingly, the disclosed invention is to be considered merely as illustrative and limited in scope only as specified in the appended claims.

What is claimed is:

1. A master imprint template for use in imprinting magnetic recording disks comprising:
an ultraviolet-transparent substrate having a generally planar surface with a center;
a metallic layer on the substrate surface and resistant to etching in a fluorine-containing plasma, the metallic layer having a thickness greater than or equal to 1 nm and less than or equal to 5 nm; and
a plurality of silicon dioxide pillars extending from the metallic layer and arranged into generally radial spokes from said substrate center and generally concentric rings about said substrate center.

2. The master imprint template of claim 1 further comprising a film of silicon dioxide having a thickness greater than or equal to 0.5 nm and less than or equal to 5 nm on the pillars and on regions of the metallic layer between the pillars.

3. The master imprint template of claim 1 wherein the metallic layer is formed of a material selected from Cr, Al, Rh, Ru, Pt, Ni, Pt and alloys thereof.

4. The master imprint template of claim 1 wherein the metallic layer is formed of a material selected from oxides of Cr, Al, Cu, Ni and Fe and oxides of alloys of Cr, Al, Cu, Ni and Fe.

5. The master imprint template of claim 1 further comprising an adhesion layer formed of a material selected from Ta, Si, Ti and Cr between the substrate and the metallic layer.

6. The master imprint template of claim 1 further comprising an adhesion layer formed of a material selected from Ta, Si, Ti and Cr between the metallic layer and the silicon dioxide pillars.

7. The master imprint template of claim 1 wherein the substrate is formed of fused quartz.

8. The master imprint template of claim 1 wherein the silicon dioxide pillars have a generally rectangular shape.

9. A master imprint template for use in imprinting magnetic recording disks comprising:
an ultraviolet-transparent substrate having a generally planar surface with a center;
a metallic layer on the substrate surface and resistant to etching in a fluorine-containing plasma, the metallic layer having a thickness greater than or equal to 1 nm and less than or equal to 5 nm;
a plurality of silicon dioxide pillars extending from the metallic layer, the pillars having a generally rectangular shape and arranged into generally radial spokes from said substrate center and generally concentric rings about said substrate center; and
a film of silicon dioxide having a thickness greater than or equal to 0.5 nm and less than or equal to 5 nm on the pillars and on regions of the metallic layer between the pillars.

10. The master imprint template of claim 9 wherein the metallic layer is formed of a material selected from Cr, Al, Rh, Ru, Pt, Ni, Pt and alloys thereof.

11. The master imprint template of claim 9 wherein the metallic layer is formed of a material selected from oxides of Cr, Al, Cu, Ni and Fe and oxides of alloys of Cr, Al, Cu, Ni and Fe.

12. The master imprint template of claim 9 further comprising an adhesion layer formed of a material selected from Ta, Si, Ti and Cr between the substrate and the metallic layer.

13. The master imprint template of claim 9 further comprising an adhesion layer formed of a material selected from Ta, Si, Ti and Cr between the metallic layer and the silicon dioxide pillars.

14. The master imprint template of claim 9 wherein the substrate is formed of fused quartz.
